(19) United States
(12) Patent Application Publication
(10) Pub. No.: US 2018/0091551 A1
(43) Pub. Date: Mar. 29, 2018

(54) TECHNIQUES FOR TLS / IPSEC ACCELERATION IN DATA CENTERS

(71) Applicant: QUALCOMM Incorporated, San Diego, CA (US)

(72) Inventors: Anand PALANIGOUNDER, San Diego, CA (US); Rosario CAMMAROTA, San Diego, CA (US); Darren LASKO, Forest, VA (US)

(21) Appl. No.: 15/277,912

(22) Filed: Sep. 27, 2016

(51) Int. Cl. H04L 29/06; H04L 9/32

(52) U.S. Cl. CPC H04L 63/166; H04L 63/0853; H04L 9/3247; H04L 63/0869

(57) ABSTRACT

Techniques for establishing one or more end-to-end secure channels in a data center are provided. A method according to these techniques includes obtaining, at a secure module (SM) associated with a virtual machine (VM) operating on a node of the data center, a VM-specific signature key for the VM from a Hardware Security Module (HSM), and performing a cryptographic signing operation at the SM associated with establishing an end-to-end secure channel between the VM and another networked entity using the VM-specific signature key responsive to a request from the VM.

### BACKGROUND

Movement of data securely to/from and within data centers requires the establishment of a large number of end-to-end secure channels (e.g. TLS or IPsec tunnels). Establishment of the tunnels requires asymmetric cryptographic operations (signatures) which are computationally intensive. Existing solutions can become a bottleneck in data centers. One existing solution is to perform signing operations in software in a trusted execution environment (TEE) paired with the Hardware Security Module (HSM) so that each node is associated with its own HSM. Problems with this solution include: (1) high overhead and latency, (2) requires a lot of computing resources, (3) signatures on the HSM are slow, and (4) presence of one HSM per node is very expensive. Another existing solution is to off-load signing operations to secure processor paired with the HSM per data center node (server). Signing operations become faster and can line up with the rate of secure tunnel establishments required by data center. But, the requirement of one HSM per node is too expensive.

### SUMMARY

An example method for establishing one or more end-to-end secure channels in a data center according to the disclosure includes obtaining, at a secure module (SM) associated with a virtual machine (VM) operating on a node of the data center, a VM-specific signature key for the VM from a Hardware Security Module (HSM), and performing a cryptographic signing operation at the SM associated with establishing an end-to-end secure channel between the VM and another networked entity using the VM-specific signature key responsive to a request from the VM.

Implementations of such a method can include one or more of the following features. Obtaining the VM-specific signature key include receiving a request from the VM to the SM requesting that the SM establish a secure channel with the HSM through which the VM can perform mutual authentication with the HSM, and establishing the secure channel with the HSM. Receiving, at the SM, the VM-specific signature key from the HSM responsive to the mutual authentication being successful. Storing the VM-specific signature key in the SM. Deleting the VM-specific signature key from the SM responsive to the end-to-end secure channel being closed or the VM terminating. The end-to-end secure channel is a Transport Layer Security (TLS) or Internet Protocol Security (IPsec) tunnel.

An example apparatus according to the disclosure includes a node of a data center and a secure module. The node of the data center includes a processor configured to execute a virtual machine (VM). The secure module is coupled to the processor of the node and configured to obtain a VM-specific signature key for the VM from a Hardware Security Module (HSM), and perform a cryptographic signing operation at the SM associated with establishing an end-to-end secure channel between the VM and another networked entity using the VM-specific signature key responsive to a request from the VM. The secure module being configured to obtain the VM-specific signature key is further configured to: receive a request from the VM to the SM requesting that the SM establish a secure channel with the HSM through which the VM can perform mutual authentication with the HSM, and establish the secure connection with the HSM. The secure module is further configured to receive the VM-specific signature key from the HSM responsive to the mutual authentication being successful. The secure module is further configured to store the VM-specific signature key in the secure module. The secure module is further configured to delete the VM-specific signature key from the SM responsive to the end-to-end secure channel being closed or the VM terminating. The end-to-end secure channel comprises a Transport Layer Security (TLS) or Internet Protocol Security (IPsec) tunnel.

An example apparatus according to the disclosure includes means for obtaining, at a secure module (SM) associated with a virtual machine (VM) operating on a node of a data center, a VM-specific signature key for the VM from a Hardware Security Module (HSM), and means for obtaining performing a cryptographic signing operation at the SM associated with establishing an end-to-end secure channel between the VM and another networked entity using the VM-specific signature key responsive to a request from the VM.

Implementations of such an apparatus can include one or more of the following features. The means for obtaining the VM-specific signature key include means for receiving a request from the VM to the SM requesting that the SM establish a secure channel with the HSM through which the VM can perform mutual authentication with the HSM, and means for establishing the secure channel with the HSM. Means for receiving, at the SM, the VM-specific signature key from the HSM responsive to the mutual authentication being successful. Means for storing the VM-specific signature key in the SM. Means for deleting the VM-specific signature key from the SM responsive to the end-to-end secure channel being closed or the VM terminating. The end-to-end secure channel comprises a Transport Layer Security (TLS) or Internet Protocol Security (IPsec) tunnel.

An example non-transitory, computer-readable medium, having stored thereon computer-readable instructions for establishing one or more end-to-end secure channels in a data center, according to the disclosure includes instructions configured to cause a computing device to obtain, at the computing device associated with a virtual machine (VM) operating on a node of the data center, a VM-specific signature key for the VM from a Hardware Security Module (HSM), and perform a cryptographic signing operation associated with establishing an end-to-end secure channel between the VM and another networked entity using the VM-specific signature key responsive to a request from the VM. The instructions configured to cause the computing device to obtain the VM-specific signature key include instructions configured to cause the computing device to receive a request from the VM requesting that the computing device establish a secure channel with the HSM through which the VM can perform mutual authentication with the HSM, and establish the secure channel with the HSM. Instructions configured to cause the computing device to receive the VM-specific signature key from the HSM responsive to the mutual authentication being successful. Instructions configured to cause the computing device to store the VM-specific signature key in the computing device. Instructions configured to cause the computing device to delete the VM-specific signature key responsive to the end-to-end secure channel being closed or the VM terminating. The end-to-end secure channel is a Transport Layer Security (TLS) or an Internet Protocol Security (IPsec) tunnel.

### BRIEF DESCRIPTION OF THE DRAWINGS

FIG. 1 is a functional block diagram of an example data center 100 in which the techniques disclosed herein can be implemented.

FIG. 2 is a functional block diagram of a portion of the data center illustrated in FIG. 1 that illustrates the interaction between a virtual machine running on a node with the HSM.

FIG. 3 is a functional diagram of an example process computing device that can be used to implement various components of the data center according to the techniques disclosed herein.

FIG. 4 is a flow diagram of an example process for establishing one or more end-to-end secure channels in a data center according to the techniques disclosed herein.

FIG. 5 is a flow diagram of an example process for establishing one or more end-to-end secure channels in a data center according to the techniques disclosed herein.

FIG. 6 is a flow diagram of an example process for obtaining a VM-specific signature key according to the techniques disclosed herein.

FIG. 7 is a flow diagram of an example process for obtaining a VM-specific signature key according to the techniques disclosed herein.

FIG. 8 is a flow diagram of an example process for managing a VM-specific signature key according to the techniques disclosed herein.

FIG. 9 is a flow diagram of an example process for managing a VM-specific signature key according to the techniques disclosed herein.

### DETAILED DESCRIPTION

Techniques for establishing end-to-end secure channels in a data center are provided. These end-to-end secure channels can include Internet Protocol Security (IPsec) and/or Transport Layer Security (TLS) tunnels. The techniques disclosed herein can used to accelerate the process of setting up and such tunnels in a data center, which can become a bottleneck for data center applications using conventional techniques for setting up such tunnels.

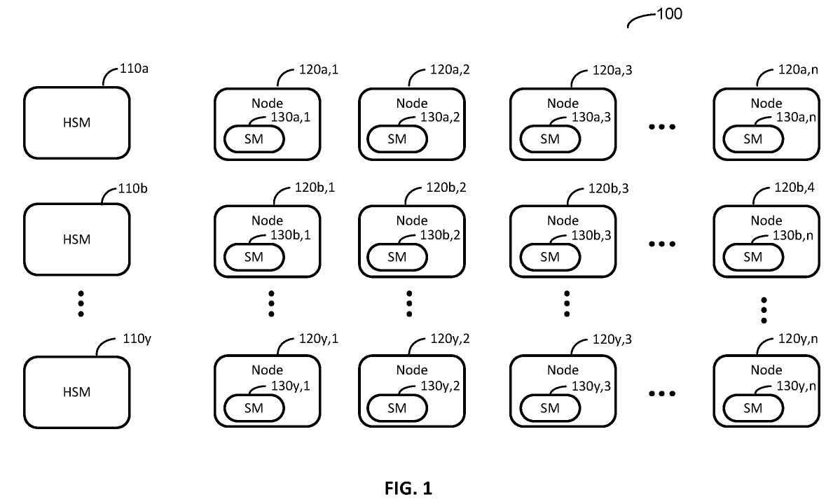

FIG. 1 is a functional block diagram of an example data center 100 in which the techniques disclosed herein can be implemented. The data center includes Hardware Security Modules (HSMs) 110 and nodes 120. A typical data center includes additional systems, such as network hardware, power systems, cooling systems, access control and security systems, and/or other components that have been omitted from the figure in order to more clearly illustrate the concepts discussed herein.

The nodes 120 comprise computing devices that are configured to perform computational and can include one or more processors, volatile and/or non-volatile computer memory, processor executable software components, and a network interface that allows the nodes 120 to communicate with other nodes, the HSMs 110, and/or other networked devices, which may be located in or outside of the data center 100.

In the example illustrated in FIG. 1, the nodes are arranged in a grid pattern comprising rows (representing as rows a toy) and columns (columns 1 to n). Each row of the grid pattern includes n nodes. The n nodes in the row share an HSM 110. The HSM 110 is configured to manage cryptographic keys and to perform cryptographic operations on behalf of the nodes 120 associated with the HSM. Each node of the nodes 120 can be configured to execute one or more virtual machines (VMs). Each virtual machine provides an operating system and/or application execution environment that imitates dedicated hardware. An operating system or application operating on the VM would be provided the same experience as if the operating system and application were operating on the dedicated hardware. Each node of the plurality of nodes 120 can support multiple running VMs, and the VMs can share the computing resources of the node 120. Cloud computing and other applications can make use of such virtualized environments to provide distributed computing resources that do not need to interact with or be aware of the underlying physical equipment of the nodes 120 on which the computing resources are running.

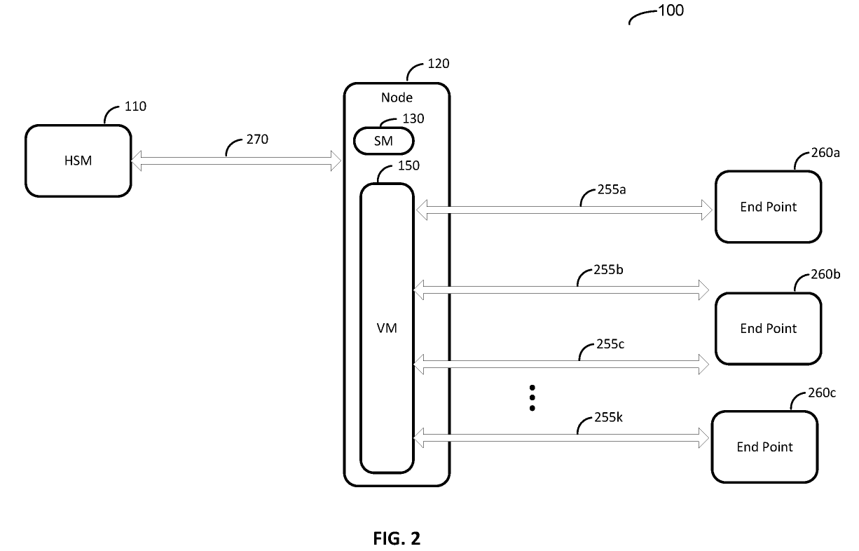

Each node of the nodes 120 can include a secure module (SM) 130 that provides a trusted execution environment. The secure module 130 provides a trusted execution environment that can be configured to perform cryptographic operations and other operations on behalf of virtual machines and/or other program code being executed by the node 120. The secure module 130 can be configured to offload performing cryptographic operations and management of cryptographic keys from the HSM 110 to reduce the load on the HSM 110 without requiring that each node of the nodes 120 of the data center 100 have a dedicated HSM 110. FIGS. 2-9 illustrate in detail how the SM 130 can be configured to interact with the HSM 110.

FIG. 2 is a functional block diagram of a portion of the data center 100 illustrated in FIG. 1 that illustrates the interaction between a virtual machine 150 running on a node 120 with the HSM 110. The virtual machine 150 can be configured to open one or more end-to-end secure channels 255, such as IPsec and/or TLS tunnels. The end-to-end secure channels 255 can provide secure communication channels between the VM 150 and one or more end points 260. The end points 260 can comprise another node of the data center 100, a VM operating on another node of the data center 100, or may comprise a computing device external to the data center 100. The virtual machine 150 may open and close numerous tunnel connections in a short period of time.

Establishing end-to-end secure channels 255 requires cryptographic keys associated with the VM 150 so that the VM 150 can authenticate itself with an endpoint using asymmetric cryptographic operations. According to the techniques disclosed herein, the secure module 130 of the node can offload some of the cryptographic operations from the HSM 110 to avoid the HSM 110 becoming a bottleneck for the virtual machine 150 operating on the nodes 120 associated with that HSM 110. Roots of Trust (RoT) can be established between the HSM 110 and the SM 130 of each node 120 associated with the HSM 110. The RoT can be established so that the HSM 110 recognizes the SM 130 of each of the nodes 120 as a trusted entity with which the HSM 110 can share encryption keys and/or other sensitive information. The HSM 110 can then safely and securely offload the management of VM-specific signature keys and the performance of cryptographic operations using the VM-specific signature keys to the SM 130.

The HSM 110 can be configured to provide an SM 130 with the VM-specific signature key or keys associated with a VM 150 running on the node on which the SM 130 is disposed responsive to the VM 150 and the HSM 110 performing mutual authentication to ensure that the HSM 110 only distributes signature keys to an SM 130 of a node where the VM 150 is running. An instance of a VM 150 may be running on multiple nodes of the nodes 120 of the data center 100 and this negotiation process can be performed for each node 120 on which an instance of the VM 150 is running. The VM 150 can be configured to request that the SM 130 of the node 120 on which the VM 150 is running establish a secure communication channel 270 with the HSM 110 associated with group of nodes to which the node 120 belongs. The SM 130 can establish a secure communication channel 270 using authentication keys and/or other RoT information that identifies the SM 130 to the HSM 110.

The secure communication channel 270 can comprise an IPsec tunnel, a TLS tunnel, or other such secure communication channel established by the SM 130 with the HSM 110. The data transmitted between the VM 150 and the HSM 110 via the tunnel can be encrypted and authenticated to ensure the origin, integrity, and confidentiality of the data communicated between the VM 150 and the HSM 110. The secure communication channel 270 can also be configured to prevent replay attacks where a third party attempts to replay previously exchanged data to trick the HSM 110 into believing that the HSM 110 is communicating with the SM 130 or the VM 150.

The VM 150 and the HSM 110 can perform mutual authentication via the secure communication channel 270 established between the SM 130 and the HSM 110. The VM 150 and the HSM 110 can use preconfigured credentials for performing the authentication procedure.

Once the mutual authentication procedure has been completed, the HSM 110 can be configured to transfer a copy of a VM-specific signature key associated with the VM 150 to the SM 130 via the secure communication channel 270. The VM-specific signature key is a private key associated with the VM 150 that can be used to perform cryptographic operations, such as generating cryptographic signatures for the VM 150. In a conventional data center configuration, the HSM 110 would maintain the copy of the VM-specific signature key and could be requested to perform cryptographic operations using the key on behalf of the VM 150. However, as discussed above, such a configuration can lead to bottlenecks where numerous VMs require the services of the HSM simultaneously, which can cause delays in establishing end-to-end secure channels for the VM 150 and/or other actions that require cryptographic processing that the VM 150 may require. According to the techniques disclosed here, the HSM 110 can transfer a copy of the VM-specific signature key to the SM 130 of the node 120 on which the VM 150 is running and the SM 130 can securely manage the VM-specific signature key and perform cryptographic operations on behalf of the VM using the VM-specific signature key. For example, the SM 130 can be configured to perform cryptographic signing operations using the VM-specific signature key in response to requests from the VM 150. The VM 150 can be configured to request that the SM 130 perform such a cryptographic action on behalf of the SM 130 as the VM 150 is setting up a secure end-to-end connection with an end point 160. The VM 150 can access the VM-specific signature key indirectly via the SM 130 at a much higher rate than may be possible via the HSM 110. Accordingly, the VM 150 can avoid the bottlenecks associated with the HSM 110 managing VM-specific signature keys for the VM 150 that could delay the establishment of secure end-to-end channels by the VM 150. The SM 130 can be configured to delete the VM-specific key from the memory of the SM 130 responsive to the VM 150 terminating on the node 120 on which the SM 130 and the instance of the VM 150 were disposed. The SM 130 can also be configured to delete the VM-specific key from the memory of the SM 130 responsive to the VM 150 terminating a secure end-to-end connection with an end point 160.

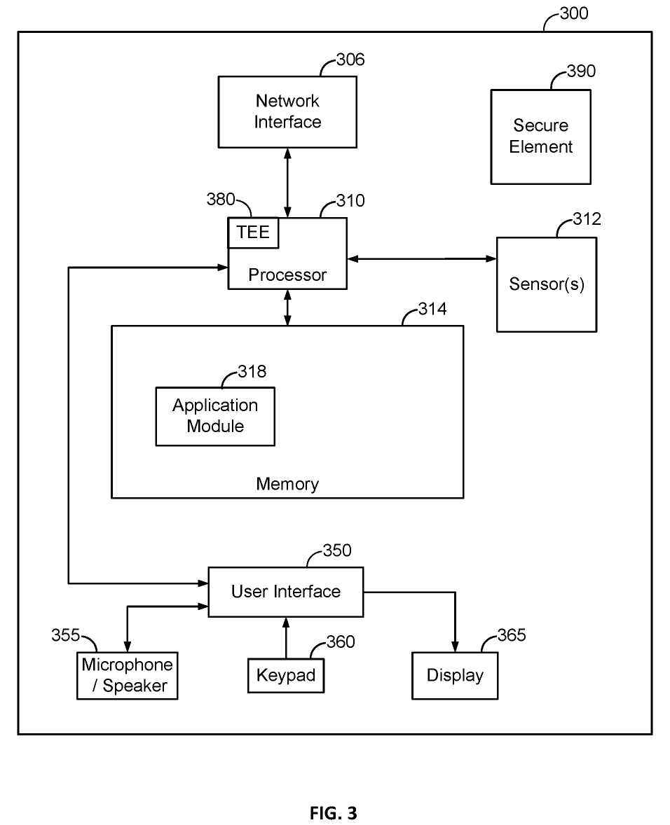

FIG. 3 is a functional diagram of an example computing device 300 that can be used to implement various components of the data center according to the techniques disclosed herein. For example, the computing device 300 can be used to implement the nodes 120 or the HSMs 110 illustrated in FIGS. 1 and 2. FIG. 3 is a schematic diagram illustrating various components of an example computing device 300, which may be similar to or the same as the nodes 120 or the HSMs 110 illustrated in FIGS. 1 and 2. For the sake of simplicity, the various features/components/functions illustrated in the schematic boxes of FIG. 3 are connected together using a common bus to represent that these various features/components/functions are operatively coupled together. Other connections, mechanisms, features, functions, or the like, may be provided and adapted as necessary to operatively couple and configure a portable wireless device. Furthermore, one or more of the features or functions illustrated in the example of FIG. 3 may be further subdivided, or two or more of the features or functions illustrated in FIG. 3 may be combined. Additionally, one or more of the features or functions illustrated in FIG. 3 may be excluded.

The computing device 300 may include a network interface 306 that enables the computing device 300 to communicate with other networked computing devices. The network interface can be configured to provide high-speed wired communications between the computing device 300 and other networked computing devices. In some implementations, the computing device 300 may include wireless networking capabilities that enable the computing device 300 to communicate with wireless networking enabled computing devices. Various types of wireless communication protocols may be used, including but not limited to WiFi (802.11x), Ultra Wide Band, ZigBee, wireless USB, etc.

As further illustrated in FIG. 3, the example computing device 300 may include one or more sensors 312 coupled to a controller/processor 310. The one or more sensors 312 can be configured to collect data that can be used to identify tampering with the computing device 300 or identify environmental conditions in the data center 100 that may be detrimental to the computing device 300. For example, the one or more sensors 312 can include a thermometer for measuring the ambient temperature at the computing device 300 and/or a humidity sensor for measuring atmospheric humidity at the computing device. Excess heat and/or humidity could potentially damage the computing device 300 and the computing device 300 can be configured to trigger and alert if the temperature and/or humidity exceed a predetermined operating threshold. Other types of sensors, such as motion sensors can also be included to measure vibrations and other motion that potentially damage the computing device 300.

The processor(s) (also referred to as a controller) 310 may be connected to the network interface 306 and the one or more sensors 312. The processor may include one or more microprocessors, microcontrollers, and/or digital signal processors that provide processing functions, as well as other calculation and control functionality. The processor 310 may be coupled to storage media (e.g., memory) 314 for storing data and software instructions for executing programmed functionality within the mobile device. The memory 314 may be on-board the processor 310 (e.g., within the same IC package), and/or the memory may be external memory to the processor and functionally coupled over a data bus.

A number of software modules and data tables may reside in memory 314 and may be utilized by the processor 310 in order to manage both communications with remote devices/nodes, perform positioning determination functionality, and/or perform device control functionality. As illustrated in FIG. 3, in some embodiments, the memory 314 may include an application module 318 which can implement one or more applications. It is to be noted that the functionality of the modules and/or data structures may be combined, separated, and/or be structured in different ways depending upon the implementation of the computing device 300.

The application module 318 may be a process running on the processor 310 of the computing device 300, which may request position information from the application module 318 or other data from one of the other modules of the computing device 300. Applications typically run within an upper layer of the software architectures and may be implemented in a rich execution environment of the computing device 300, and may include applications configured to control the operation of the computing device 300 and/or other components of the data center 100.

The processor 310 may include a trusted execution environment 380 and/or the computing device 300 may include a secure element 390. The trusted execution environment 380 and/or the secure element 390 can be used to implement a secure processing environment for storing cryptographic keys and for performing cryptographic operations. The trusted execution environment 380 can be implemented as a secure area of the processor 310 that can be used to process and store sensitive data in an environment that is segregated from the rich execution environment in which the operating system and/or applications (such as those of the application module 318) may be executed. The trusted execution environment 380 can be configured to execute trusted applications that provide end-to-end security for sensitive data by enforcing confidentiality, integrity, and protection of the sensitive data stored therein. The trusted execution environment 380 can be used to store encryption keys, anti-replay counter data, and/or other sensitive data.

The computing device 300 may include a secure element 390 (also referred to herein as a trusted component). The computing device 300 may include the secure element 390 in addition to or instead of the trusted execution environment 380. The secure element 390 can comprise autonomous and tamper-resistant hardware that can be used to execute secure applications and the confidential data associated with such applications. The secure element 390 can be used to store encryption keys, anti-replay counter data, and/or other sensitive data. The secure element 390 can be integrated with the hardware of the computing device 300 in a permanent or semi-permanent fashion or may, in some implementations, be a removable component of the computing device 300 that can be used to securely store data and/or provide a secure execution environment for applications.

The computing device 300 may further include a user interface 350 providing suitable interface systems, such as a microphone/speaker 352, a keypad 354, and a display 356 that allows user interaction with the computing device 300. The microphone/speaker 352 provides for voice communication services. The keypad 354 may comprise suitable buttons for user input. The display 356 may include a suitable display, such as, for example, a backlit LCD display, and may further include a touch screen display for additional user input modes.

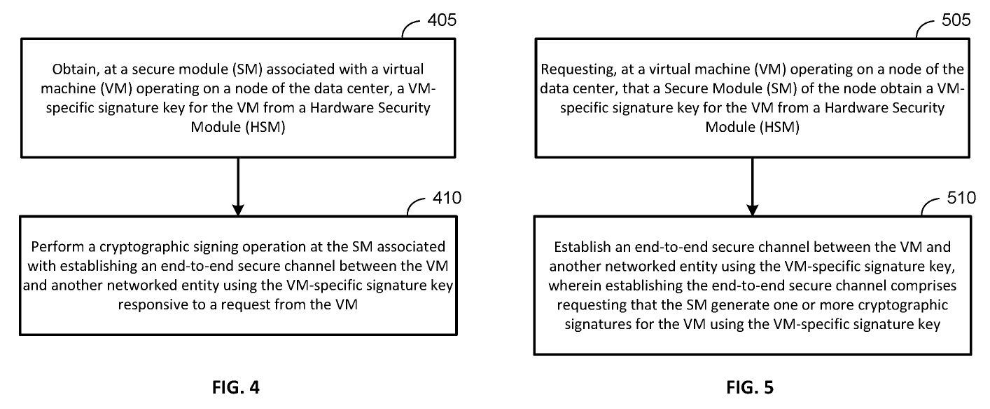

FIG. 4 is a flow diagram of an example process for establishing one or more end-to-end secure channels in a data center according to the techniques disclosed herein. The process illustrated in FIG. 4 can be implemented by a secure module 130 of a node 120 of the data center 100.

A VM-specific signature key for the VM from a Hardware Security Module (HSM) can be obtained (stage 405). The secure module 130 can be configured to obtain a VM-specific signature key associated with a virtual machine 150 operating on the node 120 on which the secure module 130 is disposed. The SM 130 and the HSM 110 have previously established RoT information that the SM 130 can use to authenticate itself with the HSM 110 and to establish a secure communication channel 270 with the HSM 110. The HSM 110 can be configured to establish the secure communication channel 270 with the HSM 110 and to notify the VM 150 that the secure communication channel 270 has been created. The HSM 110 can be configured to manage VM-specific signature keys, encryption keys, and/or other cryptographic information for the VM 150. The HSM 110 can be configured to allow the VM 150 to request the VM-specific key or keys associated with the VM 150 where the instance of the VM 150 is being executed on a node 120 of the data center 100 that includes a SM 130. The HSM 110 can determine that the VM 150 is operating on such a node 120 when the SM 130 opens a secure communication channel, such as the secure communication channel 270 to the HSM 110 using the RoT information exchanged between the HSM 110 and the SM 130.

A cryptographic signing operation at the SM associated with establishing an end-to-end secure channel between the VM and another networked entity using the VM-specific signature key can be performed responsive to a request from the VM (stage 410). The SM 130 can be configured to perform one or more cryptographic operations on behalf of the VM 150 using the VM-specific signature key. For example, the VM 150 can be configured to generate cryptographic signatures using the VM-specific signature key as part of a process of establishing an end-to-end secure channel between the VM 150 and an end point 160, such as an IPsec tunnel or a TLS tunnel. Establishing the end-to-end secure channel can include mutual authentication between the VM 150 and the end point 160 and setting up the secure communication channel between the VM 150 and the end point 160. The SM 130 can be configured to perform cryptographic operations on behalf of the VM 150 that are required for establishing the secure channel between the VM and another networked entity and/or other cryptographic operations.

FIG. 5 is a flow diagram of an example process for establishing end-to-end secure channels in a data center according to the techniques disclosed herein. The process illustrated in FIG. 5 can be implemented by a virtual machine 150 operating on a node 120 of the data center 100.

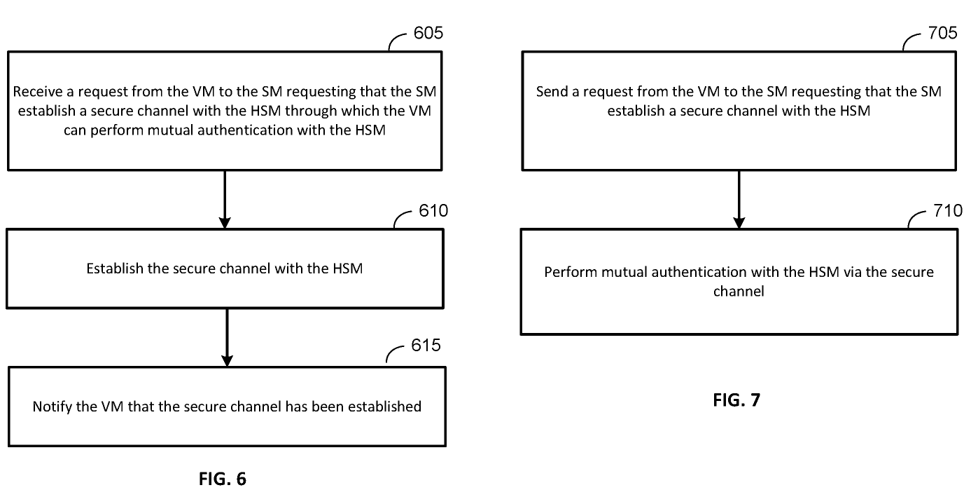

A request can be made to the secure module 130 operating on the node 120 on which the virtual machine 150 is operating to obtain a VM-specific signature key for the VM 150 from a HSM 110 (stage 505). In some implementations, the VM 150 can be configured to request that the SM 130 obtain a VM-specific signature key from the HSM 110 and manage the VM-specific signature key on behalf of the VM 150. The SM 130 an be configured to establish a secure communication channel 270 between the SM 130 and the HSM 110 and facilitate the mutual authentication of the VM 150 and the HSM 110 via the secure communication channel 270 in order to obtain the key in response to the request from the VM 150. Examples of establishing such a secure communication channel 270 and for obtaining the VM-specific signature key are illustrated in FIGS. 6-9, which are discussed in detail below.

An end-to-end secure channel between the VM 150 and another networked entity can be established using the VM-specific signature key (stage 510). Establishing the end-to-end secure channel can include requesting that the SM 130 generate one or more cryptographic signatures for the VM using the VM-specific signature key. Establishing the end-to-end secure channel can include mutual authentication between the VM 150 and the end point 160 and setting up the secure communication channel between the VM 150 and the end point 160. The SM 130 can be configured to perform cryptographic operations on behalf of the VM 150 that are required for establishing the secure channel between the VM and another networked entity and/or other cryptographic operations.

The SM 130 can be configured to perform one or more cryptographic operations on behalf of the VM 150 using the VM-specific signature key. For example, the VM 150 can be configured to generate cryptographic signatures using the VM-specific signature key as part of a process of establishing an end-to-end secure channel between the VM 150 and an end point 160, such as an IPsec tunnel or a TLS tunnel. Establishing the end-to-end secure channel can include mutual authentication between the VM 150 and the end point 160 and setting up the secure communication channel between the VM 150 and the end point 160. The SM 130 can be configured to perform cryptographic operations on behalf of the VM 150 that are required for establishing the secure channel between the VM 150 and another networked entity and/or other cryptographic operations.

FIG. 6 is a flow diagram of an example process for obtaining a VM-specific signature key according to the techniques disclosed herein. The process illustrated in FIG. 6 can be implemented by a secure module 130 of a node 120 of the data center 100.

A request can be received from the virtual machine 150 requesting that the secure module 130 establish a secure channel with the HSM 110 through which the VM 150 can perform mutual authentication with the HSM 110 (stage 605). The VM 150 can request that the SM 130 set up a secure communication channel 270 between the SM 130 and the VM 150. The VM 150 can securely communicate with the HSM 110 via the SM 130 and this secure communication channel 270. The VM 150 can use this secure communication channel 270 to perform mutual authentication with the HSM 110 so that the VM 150 can obtain a copy of the VM-specific signature keys or other encryption keys maintained for the VM 150 by the HSM 110.

A secure communication channel 270 can be established with the HSM 110 (stage 610). The secure communication channel 270 can comprise an IPsec tunnel, a TLS tunnel, or other such secure communication channel established by the SM 130 with the HSM 110. The data transmitted between the VM 150 and the HSM 110 via the tunnel can be encrypted and authenticated to ensure the origin, integrity, and confidentiality of the data communicated between the VM 150 and the HSM 110. The secure communication channel 270 can also be configured to prevent replay attacks where a third party attempts to replay previously exchanged data to trick the HSM 110 into believing that the HSM 110 is communicating with the SM 130 or the VM 150.

The VM 150 can be notified that the secure channel has been established (stage 615). The VM 150 can be configured to notify the SM 130 that the secure communication channel 270 between the SM 130 and the HSM 110 has been established and that the VM 150 can communicate with the HSM 110 via the secure communication channel 270.

FIG. 7 is a flow diagram of an example process for obtaining a VM-specific signature key according to the techniques disclosed herein. The process illustrated in FIG. 7 can be implemented by a virtual machine 150 operating on a node 120 of the data center 100.

A request can be sent to the secure module 130 of the node 120 on which the virtual machine 150 is operating to establish a secure channel with the HSM 110 (stage 705). The VM 150 can request that the SM 130 open a secure communication channel 270 to the HSM 130 over which the VM 150 can perform mutual authentication with the HSM 110. SM 130 can be configured to establish the secure communication channel 270 and to notify the VM 150 that the channel has been established. The SM 130 be configured to establish the secure communication channel 270 using a technique similar to that discussed above with respect to stage 610 of the process illustrated in FIG. 6.

The VM 150 can perform mutual authentication with the HSM 110 via the secure channel responsive to the secure channel being established (stage 710). The VM 150 can include one or more certificates that can be used to authenticate the VM 150 with the HSM 110. The VM 150 can include a public-private key pair, and the VM 150 can generate a cryptographic signature or a cryptogram using the private key of the key pair and to send the cryptographic signature to the HSM 110 to authenticate the VM 150 to the HSM 110. The VM 150 and the HSM 110 can share a VM-specific secret key that is known only to the HSM 110 and the VM 150. A cryptogram, as used herein, can refer to the output of an encryption algorithm that has been generated using a secret key (or a key derived therefrom) which is known to the VM 150 and the HSM 110. A cryptographic signature, as used herein, can refer to the output of an cryptographic algorithm using a private key of a public-private key associated with the VM 150 or the HSM 110, which is generating the cryptographic signature. The HSM 110 can be configured generate a cryptographic signature or cryptogram and to send the cryptographic signature or cryptogram to the VM 150 to authenticate the HSM 110 to the VM 150. Other techniques can also be used by the VM 150 and the HSM 110 to mutually authenticate the other entity. If either the VM 150 or the HSM 110 is unable to authenticate the other device, the process can end and the VM-specific key or keys will not be provided to the SM 130 on the node on which the VM 150 is being executed. Otherwise, if the mutual authentication is successful, the HSM 110 can be configured to provide the VM-specific key or keys associated with the VM 150 to the SM 130.

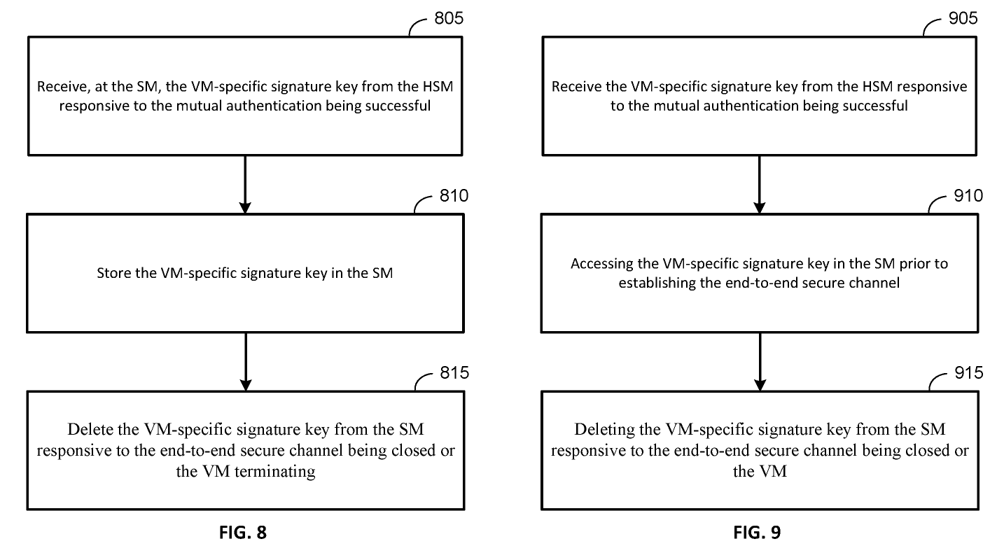

FIG. 8 is a flow diagram of an example process for managing a VM-specific signature key according to the techniques disclosed herein. The process illustrated in FIG. 6 can be implemented by a secure module 130 of a node 120 of the data center 100. The process illustrated in FIG. 6 can be implemented as additional stages of the process illustrated in FIGS. 4 and 6.

A VM-specific signature key can be received from the HSM 110 (stage 805). The HSM 110 can be configured to send the VM-specific signature key to the SM 130 via the secure communication channel 270 that the SM 130 established between the HSM 110 and the SM 130. The HSM 110 can be configured to send the VM-specific signature key to the SM 130 responsive to the VM 150 and the HSM 110 successfully performing mutual authentication over the secure communication channel 270. The SM 130 can be configured to close the secure connection between the HSM 110 and the SM 130 responsive to receiving the VM-specific signature key from the HSM 110.

The VM-specific signature key can be stored in the SM 130 (stage 810). The SM 130 comprises provides for secure memory storage for the VM-specific signature key that is substantially inaccessible from outside of the SM 130. The SM 130 provides both logical and physical protection for the data stored therein, including the VM-specific signature key associated with the VM 150. The SM 130 is configured to prevent other VMs and/or processes operating on the node 120 from accessing the VM-specific signature key associated with the VM 150.

The VM-specific signature key can be deleted responsive to the end-to-end secure channel being closed or the VM terminating (stage 815). The SM 130 can be configured to clear the copy of the VM-specific signature key from the memory of the SM 130 responsive to the end-to-end secure channel associated with the VM 150 being closed or the VM 150 terminating. The VM 150 can be configured to delete the VM-specific signature key in response to the VM closing an end-to-end secure channel. For example, the VM 150 can be configured to delete the VM-specific signature key responsive to the VM 150 closing an end-to-end secure channel and the VM 150 has no other end-to-end secure channel open. The SM 130 can be configured to maintain a copy of the VM-specific signature key in the memory of the SM 130 so long as an instance of the VM 150 continues to be executed on the node 120 on which the SM 130 is disposed. The SM 130 can be configured to monitor the activities of the VM 150 and can determine whether the SM 130 has ceased to be executed on the node 120 on which the SM 130 is disposed. The SM 130 can be configured to delete the copy of the VM-specific signature key in response to the SM 130 determining that the instance of the VM 150 is no longer running on the node 120.

FIG. 9 is a flow diagram of an example process for managing a VM-specific signature key according to the techniques disclosed herein. The process illustrated in FIG. 9 can be implemented by a virtual machine 150 operating on a node 120 of the data center 100. The process illustrated in FIG. 6 can be implemented as additional stages of the process illustrated in FIGS. 7 and 9.

The VM-specific signature key can be received from the HSM 110 responsive to the mutual authentication between the HSM 110 and the VM 150 being completed successfully (stage 905). The VM-specific signature key can be received from the HSM 110 at the SM 130 of the node 120 on which the VM 150 is running. The HSM 110 can send the VM-specific key to the SM 130 via the secure communication channel 270 that the SM 130 established with the HSM 110. The SM 130 can store the VM-specific signature key in a secure memory location of the SM 130 that is substantially inaccessible from outside of the SM 130.

The VM-specific signature key can be accessed from the SM 130 prior to establishing a secure end-to-end connection (stage 910). The VM 150 does not need to access the VM-specific signature key directly. The VM-specific signature key can be maintained in the secure memory of the SM 130 and the VM 150 can be configured to indirectly access the VM-specific signature key by requesting that the SM 130 perform one or more cryptographic operations using the VM-specific signature key. The SM 130 securely stores the VM-specific signature key in an secure memory that is substantially inaccessible from outside of the SM 130, which prevents unauthorized access to the VM-specific signature key. The SM 130 can be configured to execute cryptographic operations that the VM 150 would have otherwise relied upon the HSM 110 to perform. However, because the VM-specific key is now stored on directly on the node 120 on which the VM 150 is being executed, the latency formerly introduced by requesting that the HSM 110 perform cryptographic operations can be avoided. In an conventional data center configuration, multiple nodes each running multiple VMs and/or other processes requiring cryptographic processing may simultaneously require that the HSM 110 perform cryptographic operations. Thus, the HSM 110 could become a bottleneck in the conventional data center configuration. But, relying on the SM 130, which is local to the node 120 on which the VM 150 is being executed, to manage the VM-specific key and to perform cryptographic operations for the VM 150 avoids this potential bottleneck and can reduce the number of very expensive HSMs that the data center 100 needs in order to function efficiently.

The VM-specific signature key can be deleted responsive to the end-to-end secure channel being closed or the VM terminating (stage 915). The VM 150 can be configured to send a request to the SM 130 to delete the VM-specific signature key responsive to the end-to-end secure channel being closed or responsive to the VM preparing to terminate execution on the node 120. Alternatively, the VM 130 can rely on the SM 130 to delete the copy of the VM-specific signature key as discussed above with respect to stage 815 of the process illustrated in FIG. 8.

Example implementations of a virtual machine according to the techniques disclosed herein include the following examples:
E1. A method for establishing one or more end-to-end secure channels in a data center, the method comprising:

requesting, at a virtual machine (VM) operating on a node of the data center, that a Secure Module (SM) of the node obtain a VM-specific signature key for the VM from a Hardware Security Module (HSM); and

establishing an end-to-end secure channel between the VM and another networked entity using the VM-specific signature key, wherein establishing the end-to-end secure channel comprises requesting that the SM generate one or more cryptographic signatures for the VM using the VM-specific signature key.
E2. The method of example E1, further comprising:

sending a request from the VM to the SM requesting that the SM establish a secure channel with the HSM; and

performing mutual authentication with the HSM via the secure channel.
E3. The method of example E2, further comprising:

receiving the VM-specific signature key from the HSM responsive to the mutual authentication being successful.
E4. The method of example E2, further comprising:

accessing, using the VM, the VM-specific signature key in the SM prior to establishing the end-to-end secure channel.
E5. The method of example E4, further comprising:

deleting the VM-specific signature key from the SM responsive to the end-to-end secure channel being closed or the VM.
E6. The method of example E1, wherein the end-to-end secure channel comprises a Transport Layer Security (TLS) or Internet Protocol Security (IPsec) tunnel.
E7. An apparatus comprising:
   a virtual machine operating on a node of a data center and configured to:
      request that a Secure Module (SM) of the node obtain a VM-specific signature key for the VM from a Hardware Security Module (HSM); and
      establish an end-to-end secure channel between the VM and another networked entity using the VM-specific signature key, wherein establishing the end-to-end secure channel comprises requesting that the SM generate one or more cryptographic signatures for the VM using the VM-specific signature key.
E8. The apparatus of example E7, wherein the VM is further configured to:

send a request from the VM to the SM requesting that the SM establish a secure channel with the HSM; and

perform mutual authentication with the HSM via the secure channel.
E9. The apparatus of example E8, wherein the VM is further configured to:

receive, at the SM, the VM-specific signature key from the HSM responsive to the mutual authentication being successful.
E10. The apparatus of example E8, further comprising:

access the VM-specific signature key in the SM prior to establishing the end-to-end secure channel.
E11. The apparatus of example E10, further comprising:

delete the VM-specific signature key from the SM responsive to the end-to-end secure channel being closed or the VM.
E12. The apparatus of example E7, wherein the end-to-end secure channel comprises a Transport Layer Security (TLS) or Internet Protocol Security (IPsec) tunnel.
E13. A apparatus comprising:

means for requesting, at a virtual machine (VM) operating on a node of a data center, that a Secure Module (SM) of the node obtain a VM-specific signature key for the VM from a Hardware Security Module (HSM); and

means for establishing an end-to-end secure channel between the VM and another networked entity using the VM-specific signature key, wherein the means for establishing the end-to-end secure channel comprises means for requesting that the SM generate one or more cryptographic signatures for the VM using the VM-specific signature key.
E14. The apparatus of example E13, further comprising:

means for sending a request from the VM to the SM requesting that the SM establish a secure channel with the HSM; and

means for performing mutual authentication with the HSM via the secure channel.
E15. The apparatus of example E14, further comprising:

means for receiving the VM-specific signature key from the HSM responsive to the mutual authentication being successful.
E16. The apparatus of example E14, further comprising:

means for accessing the VM-specific signature key in the SM prior to establishing the end-to-end secure channel.
E17. The apparatus of example E16, further comprising:

means for deleting the VM-specific signature key from the SM responsive to the end-to-end secure channel being closed or the VM.
E18. The apparatus of example E13, wherein the end-to-end secure channel comprises a Transport Layer Security (TLS) or Internet Protocol Security (IPsec) tunnel.
E19. A non-transitory, computer-readable medium, having stored thereon computer-readable instructions for establishing one or more end-to-end secure channels in a data center, comprising instructions configured to cause a computing device to:

request that a Secure Module (SM) of a node of the data center obtain a virtual machine (VM)-specific signature key for a VM from a Hardware Security Module (HSM); and

establish an end-to-end secure channel between the VM and another networked entity using the VM-specific signature key, wherein the instructions configured to cause the computing device to establish the end-to-end secure channel further comprise instructions configured to cause the computing device to request that the SM generate one or more cryptographic signatures for the VM using the VM-specific signature key.
E20. The non-transitory, computer-readable medium of example E19, further comprising instructions configured to cause the computing device to:

send a request from the VM to the SM requesting that the SM establish a secure channel with the HSM; and

perform mutual authentication with the HSM via the secure channel.
E21. The non-transitory, computer-readable medium of example E20, further comprising instructions configured to cause the computing device to:

receive the VM-specific signature key from the HSM responsive to the mutual authentication being successful.
E22. The non-transitory, computer-readable medium of example E20, further comprising instructions configured to cause the computing device to:

access the VM-specific signature key in the SM prior to establishing the end-to-end secure channel.
E23. The non-transitory, computer-readable medium of example E22, further comprising instructions configured to cause the computing device to:

delete the VM-specific signature key from the SM responsive to the end-to-end secure channel being closed or the VM.
E24. The non-transitory, computer-readable medium of example E19, wherein the end-to-end secure channel comprises a Transport Layer Security (TLS) or Internet Protocol Security (IPsec) tunnel.

The methodologies described herein may be implemented by various means depending upon the application. For example, these methodologies may be implemented in hardware, firmware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media. Tangible media include one or more physical articles of machine readable media, such as random access memory, magnetic storage, optical storage media, and so on.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. Such media also provide examples of non-transitory media, which can be machine readable, and wherein computers are an example of a machine that can read from such non-transitory media.

The generic principles discussed herein may be applied to other implementations without departing from the spirit or scope of the disclosure or claims.

What is claimed is:

1. A method for establishing one or more end-to-end secure channels in a data center, the method comprising:
obtaining, at a secure module (SM) associated with a virtual machine (VM) operating on a node of the data center, a VM-specific signature key for the VM from a Hardware Security Module (HSM); and
performing a cryptographic signing operation at the SM associated with establishing an end-to-end secure channel between the VM and another networked entity using the VM-specific signature key responsive to a request from the VM.

2. The method of claim 1, wherein obtaining the VM-specific signature key further comprises:
receiving a request from the VM to the SM requesting that the SM establish a secure channel with the HSM through which the VM can perform mutual authentication with the HSM; and
establishing the secure channel with the HSM.

3. The method of claim 2, further comprising:
receiving, at the SM, the VM-specific signature key from the HSM responsive to the mutual authentication being successful.

4. The method of claim 2, further comprising:
storing the VM-specific signature key in the SM.

5. The method of claim 4, further comprising:
deleting the VM-specific signature key from the SM responsive to the end-to-end secure channel being closed or the VM terminating.

6. The method of claim 1, wherein the end-to-end secure channel comprises a Transport Layer Security (TLS) or Internet Protocol Security (IPsec) tunnel.

7. An apparatus comprising:
a node of a data center comprising a processor configured to execute a virtual machine (VM); and
a secure module (SM) coupled to the processor of the node and configured to
obtain a VM-specific signature key for the VM from a Hardware Security Module (HSM), and
perform a cryptographic signing operation at the SM associated with establishing an end-to-end secure channel between the VM and another networked entity using the VM-specific signature key responsive to a request from the VM.

8. The apparatus of claim 7, wherein the secure module being configured to obtain the VM-specific signature key is further configured to:
receive a request from the VM to the SM requesting that the SM establish a secure channel with the HSM through which the VM can perform mutual authentication with the HSM; and
establish the secure connection with the HSM.

9. The apparatus of claim 8, wherein the secure module is further configured to:
receive the VM-specific signature key from the HSM responsive to the mutual authentication being successful.

10. The apparatus of claim 8, wherein the secure module is further configured to:
store the VM-specific signature key in the secure module.

11. The apparatus of claim 10, wherein the secure module is further configured to:
delete the VM-specific signature key from the SM responsive to the end-to-end secure channel being closed or the VM terminating.

12. The apparatus of claim 7, wherein the end-to-end secure channel comprises a Transport Layer Security (TLS) or Internet Protocol Security (IPsec) tunnel.

13. An apparatus comprising:
means for obtaining, at a secure module (SM) associated with a virtual machine (VM) operating on a node of a data center, a VM-specific signature key for the VM from a Hardware Security Module (HSM); and
means for obtaining performing a cryptographic signing operation at the SM associated with establishing an end-to-end secure channel between the VM and another networked entity using the VM-specific signature key responsive to a request from the VM.

14. The apparatus of claim 13, wherein the means for obtaining the VM-specific signature key further comprise:
means for receiving a request from the VM to the SM requesting that the SM establish a secure channel with the HSM through which the VM can perform mutual authentication with the HSM; and
means for establishing the secure channel with the HSM.

15. The apparatus of claim 14, further comprising:
means for receiving, at the SM, the VM-specific signature key from the HSM responsive to the mutual authentication being successful.

16. The apparatus of claim 14, further comprising:
means for storing the VM-specific signature key in the SM.

17. The apparatus of claim 16, further comprising:
means for deleting the VM-specific signature key from the SM responsive to the end-to-end secure channel being closed or the VM terminating.

18. The apparatus of claim 13, wherein the end-to-end secure channel comprises a Transport Layer Security (TLS) or Internet Protocol Security (IPsec) tunnel.

19. A non-transitory, computer-readable medium, having stored thereon computer-readable instructions for establishing one or more end-to-end secure channels in a data center, comprising instructions configured to cause a computing device to:
obtain, at the computing device associated with a virtual machine (VM) operating on a node of the data center, a VM-specific signature key for the VM from a Hardware Security Module (HSM); and
perform a cryptographic signing operation associated with establishing an end-to-end secure channel between the VM and another networked entity using the VM-specific signature key responsive to a request from the VM.

20. The non-transitory, computer-readable medium of claim 19, wherein the instructions configured to cause the computing device to obtain the VM-specific signature key further comprise instructions configured to cause the computing device to:
receive a request from the VM requesting that the computing device establish a secure channel with the HSM through which the VM can perform mutual authentication with the HSM; and
establish the secure channel with the HSM.

21. The non-transitory, computer-readable medium of claim 20, further comprising instructions configured to cause the computing device to:
receive the VM-specific signature key from the HSM responsive to the mutual authentication being successful.

22. The non-transitory, computer-readable medium of claim 20, further comprising instructions configured to cause the computing device to:
store the VM-specific signature key in the computing device.

23. The non-transitory, computer-readable medium of claim 22, further comprising instructions configured to cause the computing device to:
delete the VM-specific signature key responsive to the end-to-end secure channel being closed or the VM terminating.

24. The non-transitory, computer-readable medium of claim 19, wherein the end-to-end secure channel comprises a Transport Layer Security (TLS) or Internet Protocol Security (IPsec) tunnel.
